(19) United States
(12) Patent Application Publication
(10) Pub. No.: US 2003/0167652 A1
(43) Pub. Date: Sep. 11, 2003

(54) DRYING APPARATUS

(76) Inventor: Kazuyoshi Takagi, SHUUCHI-gun (JP)

Correspondence Address: ERNEST A. BEUTLER, ATTORNEY AT LAW, 500 NEWPORT CENTER DRIVE, SUITE 945, NEWPORT BEACH, CA, 92660, US

(21) Appl. No.: 10/248,435

(22) Filed: Jan. 20, 2003

(30) Foreign Application Priority Data
Mar. 5, 2002 (JP) 2002-058156

(51) Int. Cl. F26B 19/00; F26B 25/06

(52) U.S. Cl. 34/60; 34/203

(57) ABSTRACT

A conveyor apparatus, supporting racks and heating arrangement for heating and cooling work pieces such as magnet assemblies for rotating electric machines. Because of the closed oval path through which the work pieces are transported on the racks by means of a conveyor mechanism that does not have to support the weight of the work pieces, very high efficiencies can be obtained.

### BACKGROUND OF THE INVENTION

This invention relates to a drying apparatus and a conveyor for use therein and article supporting rack therefore that provides a very compact and effective arrangement for drying articles such as components of rotating electrical machines.

In assembling electrical machines such as electric motors or generators, a plurality of magnet segments are affixed to a cylindrical surface of an outer case. A cylindrical retainer case is fitted to the outer case to hold these magnets in place so that they are trapped between the inner and outer cases. The outer case generally is comprised of a cylindrical shell that is open at one end. The other end is closed by an end plate having a cylindrical opening at its center. The magnets are bonded with an adhesive between the inner and outer cases.

In the process of forming these magnets assemblies, it is the practice to cure the adhesive through a drying operation where the components are heated at a high temperature for a predetermined time period.

Conventionally, this heating and bonding operation takes place on a belt conveyor or roller conveyor where the work pieces are transported by the conveyor to a drying chamber and retained therein for a given period of time for the heat to dry the adhesive. However, when the work pieces are mounted side by side on a conveyor in this fashion, there is a limit to the number that can be placed in the drying chamber and the heating of the work pieces is not necessarily uniform. Furthermore, it is difficult to seal the area containing the conveyor and this results in poor thermal efficiency. In addition, the power to drive the conveyor becomes quite large since it supports the weight of the work pieces and thus, the system is quite cumbersome and inefficient. Furthermore since the work pieces are conveyed in a linear manner the return flight of the conveyor does no real work and the spatial requirements are large.

It is, therefore, a principal object to this invention to provide an improved, compact and highly effective apparatus for heat drying work pieces.

It is a further object to this invention to provide an arrangement for heat drying the work pieces where they are not only heated but cooled so that they can be readily placed into the heating chamber and removed there from.

It is a still further object to this invention to provide an improved conveyor mechanism that lends itself to a continuous process and wherein the work pieces can be easily placed on the conveyor and removed from the conveyor without requiring high driving forces for the conveyor.

It is further object to this invention to provide an improved rack arrangement for holding these types of work pieces and conveying them through the heating and cooling chambers.

### SUMMARY OF THE INVENTION

A first feature of the invention is adapted to be embodied in a drying apparatus comprising a conveyor for conveying articles along a closed path. An enclosure encloses a substantial portion of the closed path and leaves at least one open area through which articles to be dried can be inserted on the conveyor and dried articles can be removed from the conveyor. A heater heats at least a portion of the closed path enclosed by the enclosure for drying articles on the conveyor.

Another feature of the invention is adapted to be embodied in a drying apparatus as set forth above and employs a conveyor that is generally oval in top plan view having a straight downstream path and a straight return path joined at opposite ends by curved portions.

Still another feature of the invention is adapted to be embodied in a drying apparatus as set forth above and employs a heater that heats atmospheric air and delivers it to at least a part of the enclosed area through louvered walls of the enclosure.

Yet another feature of the invention is adapted to be embodied in a drying apparatus as set forth above and employs a conveyor that comprises a flexible transmitter and the articles to be dried are carried by racks supported on a floor positioned below the flexible transmitter and driven by the flexible transmitter.

Another feature of the invention is adapted to be embodied in a conveyor for conveying articles between a plurality of stations comprising a flexible transmitter positioned above a workplace floor and a plurality of racks supported on the floor and driven by the flexible transmitter.

### BRIEF DESCRIPTION OF DRAWINGS

FIG. 1 is a cross sectional view looking from above of a heat drying apparatus and conveyor system constructed in accordance with an embodiment of the invention.

FIG. 2 is a side elevational view of the apparatus looking in the direction of the arrow 2 in FIG. 1.

FIG. 3 is an end elevational view of the apparatus taken from the loading and removing end shown to the left in FIGS. 1 and 2.

FIG. 4 is a top plane view of one of the racks with its connection to the conveyor being shown in broken lines.

FIG. 5 is a front elevational view of the rack.

FIG. 6 is a partially schematic view showing how the closure doors of the heating and cooling apparatus are operated.

### DETAILED DESCRIPTION

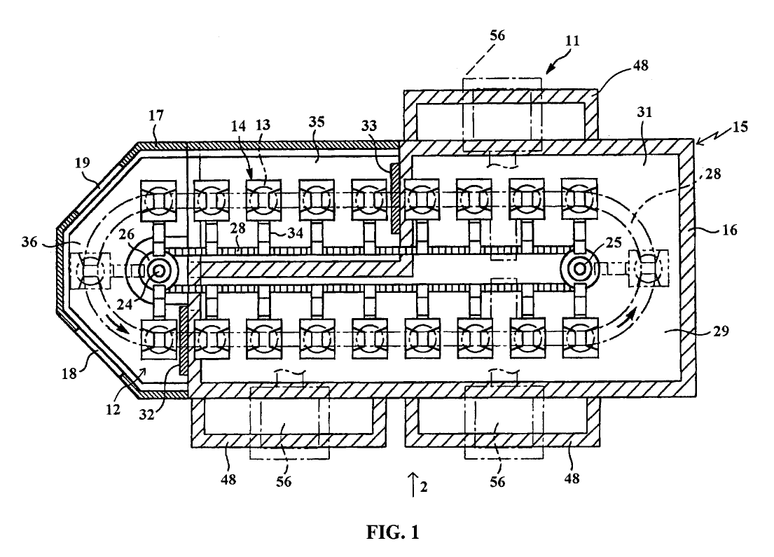

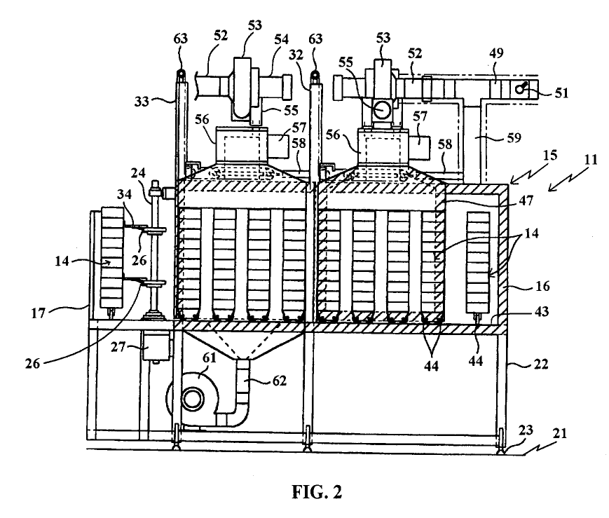

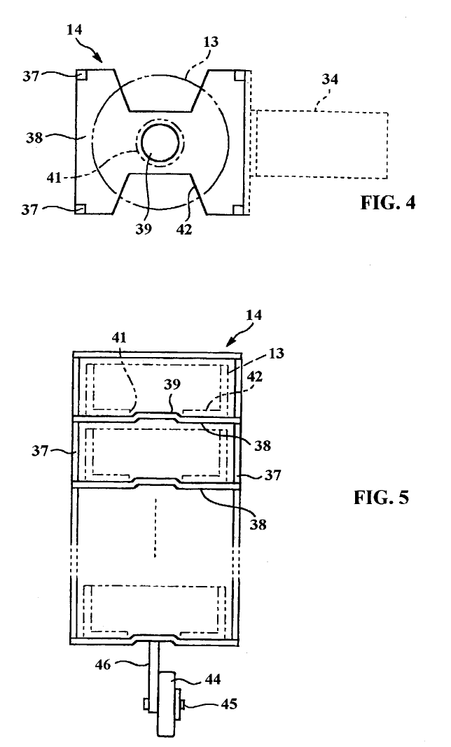

Referring now in detail to the drawings and initially primarily to FIGS. 1 through 3, a heat drying and cooling apparatus constructed in accordance with an embodiment of the invention is identified generally by the reference numeral 11. The apparatus 11 includes a conveyor apparatus, indicated generally by the reference numeral 12 that conveys a plurality of work pieces, shown in phantom in FIGS. 4 and 5 and indicated generally by the reference numeral 13,that are mounted on rack assemblies, indicated generally by the reference numeral 14, through a housing assembly, indicated generally by the reference numeral 15.

The housing assembly 15 includes a first more highly insulated portion 16 that has a generally L-shape in top plane view and a second, less highly insulated portion 17. The portion 17 protrudes at one end and has work piece insertion openings 18 and dried work piece removal openings 19. The work pieces 13 are placed upon the racks 14 through the opening 18 for heat drying and subsequent forced cooling and removed there from through the opening 19The housing assembly 15 is adapted to be placed upon a floor 21 of a factory and is supported in elevated location relative location thereto by a plurality of spaced supporting legs 22 that have adjustable leveling bases 23. Thus, the openings 18 and 19 are positioned in a convenient location and are easily accessible by workmen.

The conveyor assembly 12 is comprised of a pair of posts or shafts 24 and 25 that are rotatably journalled about vertical axes. A pair of driving sprockets 26 are affixed at axially spaced locations to the drive shaft 24 which is driven by an electric drive motor 27 mounted beneath the housing 15. The remaining shaft 25 carries like idler sprockets. A pair of conveyor chains 28 is driven by the sprockets 26 and they and the idler sprockets carried by the shaft 25 define a generally oval path of travel of the conveyor assembly 12.

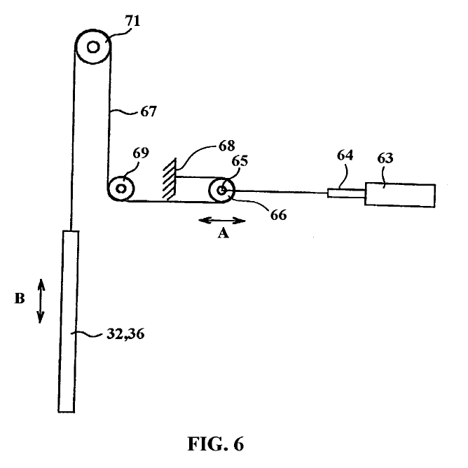

This oval path defines a pair of longitudinally extending parallel paths comprising a feed path for conveying the racks 14 first through the highly insulated portion 16 and specifically the interior cavity 29 thereof. A small portion of the return path extends though a shorter side 31 which is also heated. Openings are formed in end walls of these two heated and more highly insulated portions of the housing 16. These openings are sequentially opened and closed by an admitting door 32 and a removal door 33 which are operated in a manner which will be described later by reference to FIG. 6.

A plurality of drive arms or links 34 are affixed at spaced locations to the chains 28 and are connected to the racks 14 in a suitable manner so that the racks 14 will move through a path that also has an oval configuration. Thus the racks 14 and supported work pieces will be moved through the heating chambers 29 and 31, through a cooling chamber 35 formed at one side of the housing portion 17 and which terminates in a cavity 36 that is accessible through the openings 18 and 19.

Referring now specifically to the construction of the racks 14, these are provided with four corner posts 37 and support plates 38 that extend there between and are affixed thereto. Each of these support plates 38 has a generally H-shaped configuration with a raised central part 39. This raised central part 39 is complimentary to an opening 41 formed in a partially closed end 42 of the work piece 13. The upper end of the work piece 13 is opened as aforedescribed. Thus, by virtue of this construction, the work pieces will all be uniformly heated and cooled when passing through the housing assembly 15. Recesses 42 in the plates 38 affords good air circulation around the work pieces 13 while providing relatively rigid holding of the work pieces during their travel.

Each rack 14 is supported on a floor 43 of the housing assembly 15 by means of rollers or wheels 44 that are journalled on shafts 45 fixed at the lower end of support legs 46. As a result, the work pieces 13 and racks 14 are not supported by the conveyor assembly 12. Thus, the driving force of the chains 28 is substantially reduced and therefore the system can be operated very inexpensively. In addition, since the conveyor 12 consisting of the chains 28 and rack driving arms 34 is quite small, the heated area comprising the chamber portions 29 and 31 can be well insulated and operate at a high efficiency

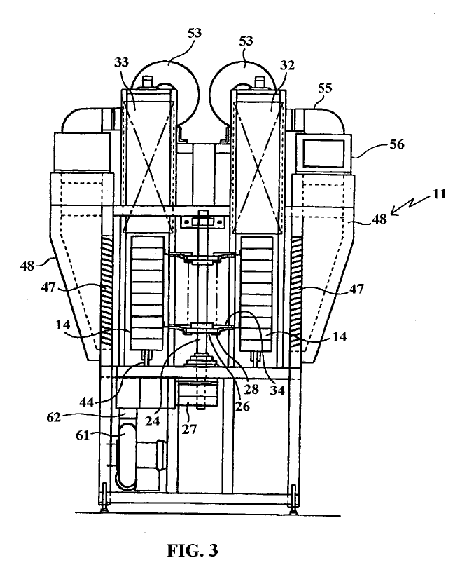

The manner in which the chamber comprising the portions 29 and 31 is heated will now be described by primary reference to FIGS. 1 through 3. The side walls of the housing portion 16 are provided with louvered openings 47 that best appear in FIG. 3. Ducts 48 enclose these louvered openings 47 and have a generally rectangular configuration with a downwardly tampering section for a reason which will become apparent shortly.

Hot air is delivered to each of the ducts 48 by a blower and heater system that includes a common atmospheric air intake 49 having a flow control valve 51 therein. This common intake 49 feeds an inlet duct 52 associated with each of a plurality of blowers each contained within a blower housing 53 and driven by a respective electric motor 54. The blower housings 53 have outlet ports 55 that communicate with heating chambers 56 at the inlet end of each duct 48 and which are provided with electric heaters 57. In addition, return passageways 58 communicate with a return duct 59 for returning excess heated air back to the inlet section 49 downstream of the control valve 51. In this way, the temperature can be accurately controlled.

Because the ducts 48 have a tampering side wall the flow area to the lowermost louvers 47 is less than that to the uppermost louvers 47. Hence there will be a uniform flow velocity through each louver 47 to provide uniform heating of the work pieces 13 supported on the racks 14.

The work pieces 13 are delivered to the heating chambers 29 and 31 by opening of the door 32 and then closing it after the next series of racks 14 has been moved into position in the heating chamber. From these heating chambers 29 and 31, the racks are discharged by opening the door 33 and permitting the racks to pass into the cooling chamber 35.

Cool atmospheric air is delivered to this chamber 35 by means of a further blower motor 61 that is positioned beneath the housing assembly 15 and which blows atmospheric air into the chamber 35 through a feed duct 62. Thus, by the time the work pieces 13 have been progressed to register with the opening 19, the work pieces 13 will be cooled and can be easily removed from the racks 14.

The mechanism for opening and closing the doors 32 and 33 is illustrated in FIG. 6. This includes a hydraulic or pneumatic cylinder 63 that has its piston rod 64 connected to the shaft 65 of a pulley 66. A drive cable 67 is fixed at one end to a fixed abutment 68 and as the piston rod 66 reciprocates in the direction of the arrow A, the drive cable 67 will raise or lower doors 32 and 36 in the direction shown by the arrow B as the drive cable 67 passes over the pulley 66 and fixed axes pulleys 69 and 71.

Thus, it should be apparent that the conveyor mechanism, racks and heating and cooling arrangement provides a very compact assembly wherein a number of work pieces can be heated uniformly and then cooled so that they can be easily inserted and removed from their supporting racks 14. Of course, the structure described represents preferred embodiments of the invention and various changes and modifications may be made without departing from the spirit and scope of the invention, as defined by the appended claims.

1. A drying apparatus comprising a conveyor for conveying articles along a closed path, an enclosure for enclosing a substantial portion of said closed path and leaving at least one open area through which articles to be dried can be inserted on said conveyor and dried articles can be removed from said conveyor, a heater for heating at least a portion of said closed path enclosed by said enclosure for drying articles on said conveyor.

2. A drying apparatus as set forth in claim 1, wherein the enclosure is formed with an opening adjacent the at least one open area through which the conveyor and articles to be dried pass and a closure for closing said opening once an article has passed through said opening.

3. A drying apparatus as set forth in claim 2, wherein the enclosure is formed with a second opening through which the conveyor and articles to be dried pass and a second closure for closing said second opening after the conveyor and articles to be dried pass.

4. A drying apparatus as set forth in claim 3, wherein the second opening and second closure are spaced a considerable distance from the first opening and door to allow sufficient heating of the articles to dry them and also spaced a considerable distance from the at least one open area through which articles to be dried can be inserted on said conveyor and dried articles can be removed from said conveyor to allow the dried articles to be cooled sufficiently to be removed from said conveyor.

5. A drying apparatus as set forth in claim 4, wherein the heater heats atmospheric air and delivers it to at least a part of the enclosed area through louvered walls of the enclosure.

6. A drying apparatus as set forth in claim 5, wherein the heated air is delivered to the louvered walls by a plurality of fans spaced along the path of the conveyor.

7. A drying apparatus as set forth in claim 6, wherein the fans supply the heated air to the louvered walls through a duct that extends through the full width of the louvers and which decreases in thickness along its length to maintain the same flow velocity through the louvers along the length of the duct.

8. A drying apparatus as set forth in claim 7, further including a cooling fan for circulating unheated atmospheric air through a portion of the conveyor path after the heated portion of the conveyor path.

9. A drying apparatus as set forth in claim 8, wherein the conveyor comprises a flexible transmitter and the articles to be dried are carried by racks supported on a floor positioned below the flexible transmitter and driven by the flexible transmitter.

10. A drying apparatus as set forth in claim 9, wherein the racks have a plurality of corner posts carrying vertically spaced partitions for supporting the articles to be dried.

11. A drying apparatus as set forth in claim 10, wherein the racks are supported on the floor by wheels.

12. A drying apparatus as set forth in claim 11, wherein the articles have a cylindrical wall closed at one end by an end wall with a cylindrical opening therein and the partitions have a raised portion complimentary to the cylindrical opening for locating and holding the article.

13. A drying apparatus as set forth in claim 12, wherein the partitions are relieved around the raised portion to permit air flow.

14. A drying apparatus as set forth in claim 1, wherein the path defined by the conveyor is generally oval in top plan view having a straight downstream path and a straight return path joined at opposite ends by curved portions.

15. A drying apparatus as set forth in claim 14, wherein the at least one open area through which articles to be dried can be inserted on the conveyor and dried articles can be removed from said conveyor is formed in one of the curved portions.

16. A drying apparatus as set forth in claim 15, wherein the at least one open area through which articles to be dried can be inserted on the conveyor and dried articles can be removed from said conveyor comprises a first open area contiguous to the beginning of said conveyor downstream path and a second open area contiguous to the downstream end of the conveyor return path.

17. A drying apparatus as set forth in claim 16, wherein the enclosure is formed with an opening adjacent the first open area through which the conveyor and articles to be dried pass and a closure for closing said opening once an article has passed through said opening.

18. A drying apparatus as set forth in claim 17, wherein the enclosure is formed with a second opening along the return path of the conveyor through which said conveyor return path and articles to be dried pass and a second closure for closing said second opening after the conveyor and articles to be dried pass.

19. A drying apparatus as set forth in claim 18, wherein the second opening and second closure are spaced a considerable distance from the first opening and door to allow sufficient heating of the articles to dry them and also spaced a considerable distance from the second open area to allow the dried articles to be cooled sufficiently to be removed from said conveyor through said second open area.

20. A drying apparatus as set forth in claim 1, wherein the heater heats atmospheric air and delivers it to at least a part of the enclosed area through louvered walls of the enclosure.

21. A drying apparatus as set forth in claim 20, wherein the heated air is delivered to the louvered walls by a plurality of fans spaced along the path of the conveyor.

22. A drying apparatus as set forth in claim 21, wherein the fans supply the heated air to the louvered walls through a duct that extends through the full width of the louvers and which decreases in thickness along its length to maintain the same flow velocity through the louvers along the length of the duct.

23. A drying apparatus as set forth in claim 22, further including a cooling fan for circulating unheated atmospheric air through a portion of the conveyor path after the heated portion of the conveyor path.

24. A drying apparatus as set forth in claim 1, wherein the conveyor comprises a flexible transmitter and the articles to be dried are carried by racks supported on a floor positioned below the flexible transmitter and driven by said flexible transmitter.

25. A drying apparatus as set forth in claim 24, wherein the racks have a plurality of corner posts carrying vertically spaced partitions for supporting the articles to be dried.

26. A drying apparatus as set forth in claim 25, wherein the racks are supported on the floor by wheels.

27. A drying apparatus as set forth in claim 24, wherein the articles have a cylindrical wall closed at one end by an end wall with a cylindrical opening therein and the partitions have a raised portion complimentary to the cylindrical opening for locating and holding the article.

28. A drying apparatus as set forth in claim 27, wherein the partitions are relieved around the raised portion to permit air flow.

29. A conveyor for conveying articles between a plurality of stations comprising a flexible transmitter positioned above a workplace floor, a plurality of racks supported on the floor and driven by said flexible transmitter.

30. A conveyor as set forth in claim 29 wherein the racks are supported on the floor by wheels.
